(19) United States
(12) Patent Application Publication
(10) Pub. No.: US 2026/0005325 A1
(43) Pub. Date: Jan. 1, 2026

(54) BATTERY PACK TERMINAL TEMPERATURE MONITORING

(71) Applicant: MILWAUKEE ELECTRIC TOOL CORPORATION, Brookfield, WI (US)

(72) Inventors: Mayada I. Issa, Milwaukee, WI (US); Derek J. Schwab, Glendale, WI (US); Jonathan D. Quenzer, German Valley, IL (US)

(21) Appl. No.: 19/256,333

(22) Filed: Jul. 1, 2025

Related U.S. Application Data
(60) Provisional application No. 63/666,557, filed on Jul. 1, 2024.

(51) Int. Cl. H01M 10/42; G01K 3/00; H01M 10/48; H01M 50/247

(52) U.S. Cl. CPC H01M 10/425; G01K 3/005; H01M 10/486; H01M 50/247; H01M 2220/30

(57) ABSTRACT

Battery pack terminal temperature monitoring. The battery pack includes a housing, a battery cell within the housing, a power terminal and a temperature terminal, and a temperature integrated circuit in thermal contact with the power terminal and electrically connected to the temperature terminal. The temperature integrated circuit is configured to detect a temperature of the power terminal, compare a temperature of the power terminal to a temperature threshold, and pull the temperature terminal low in response to the temperature of the power terminal satisfying the temperature threshold.

### CROSS-REFERENCE TO RELATED APPLCIATIONS

This application claims priority to, and the benefit of, U.S. Provisional Patent No. 63/666,557 filed Jul. 1, 2024, the contents of which are hereby incorporated by reference.

### FIELD

The present application relates to battery packs and, in particular, monitoring a terminal temperature of a battery pack.

### SUMMARY

Battery packs include terminals that facilitate the transfer of power from battery cells inside the battery pack to a device coupled to the battery pack. For example, a battery pack may be used to provide power to a power tool, such as a drill, saw, etc. To reduce cost and weight of battery packs, battery packs are typically housed in plastic housings. At high temperatures, plastic is susceptible to melting or deformation. For example, when battery pack terminals experience an overtemperature event, the battery pack housing (e.g., the housing surrounding the terminals) may melt. The melted housing may cause warping and, in extreme cases, may prohibit a user from using the battery pack. Power tools may monitor battery cell temperature at a battery pack terminal. However, power tool monitoring battery cell temperature may not prevent the battery pack housing from melting due to overheating of the battery terminal. Accordingly, it would be advantageous to provide a battery pack with an integrated circuit that performs terminal temperature monitoring while using minimal components and not requiring additional firmware to keep the battery pack housing as compact as possible.

Embodiments described herein provide a battery pack including a housing, a battery cell within the housing, a power terminal and a temperature terminal, and a temperature integrated circuit in thermal contact with the power terminal and electrically connected to the temperature terminal. The temperature integrated circuit is configured to detect a temperature of the power terminal, compare a temperature of the power terminal to a temperature threshold, and pull the temperature terminal low in response to the temperature of the power terminal satisfying the temperature threshold.

A further embodiment described herein provides a system comprising a battery pack and a power tool. The battery pack includes a device interface having a power terminal and a temperature terminal. The power tool includes a power input unit configured to connect to the device interface and a controller coupled to the power input unit. The controller is configured to determine a voltage of the temperature terminal, compare the voltage of the temperature terminal to a threshold value, and prevent, in response to determining the voltage of the temperature terminal is less than the threshold voltage, the battery pack from discharging.

An even further embodiment described herein provides a printed circuit board. The printed circuit board includes a power terminal, a temperature terminal, and a temperature integrated circuit in thermal contact with the power terminal and electrically connected to the temperature terminal. The temperature integrated circuit is configured to detect a temperature of the power terminal, compare a temperature of the power terminal to a temperature threshold, and pull the temperature terminal low in response to the temperature of the power terminal satisfying the temperature threshold.

### BRIEF DESCRIPTION OF THE DRAWINGS

FIG. 1 illustrates a battery pack for a power tool, according to some embodiments.

FIG. 2 illustrates a power tool powered by the battery pack of FIG. 1, according to some embodiments.

FIG. 3 illustrates a perspective view of a device interface of the battery pack of FIG. 1, according to some embodiments.

FIG. 4 is a perspective view of the battery pack of FIG. 1 with the housing removed, according to some embodiments.

FIG. 5 illustrates a printed circuit board of the battery pack of FIG. 1, according to some embodiments.

FIG. 6 is a simplified block diagram of the battery pack of FIG. 1, according to some embodiments.

FIG. 7 is a simplified block diagram of a temperature integrated circuit of the battery pack of FIG. 1, according to some embodiments.

FIG. 8 illustrates a heat map of the printed circuit board of FIG. 6, according to some embodiments.

FIG. 9 illustrates a heat map of the printed circuit board of FIG. 6, according to some embodiments.

FIG. 10 is a simplified schematic of the battery pack of FIG. 1, according to some embodiments.

FIG. 11 illustrates a flowchart of a method for battery pack terminal temperature monitoring, according to some embodiments.

FIG. 12 is a block diagram of a controller of the power tool of FIG. 2, according to some embodiments.

FIG. 13 illustrates a flowchart of a method for battery pack terminal temperature monitoring, according to some embodiments.

FIG. 14 is a graph illustrating the temperature-based output of the battery pack of FIG. 1, according to some embodiments.

FIG. 15 is a graph illustrating the temperature-based output of the battery pack of FIG. 1, according to some embodiments.

FIG. 16 is a graph illustrating the temperature-based output of the battery pack of FIG. 1, according to some embodiments.

### DETAILED DESCRIPTION

Before any embodiments are explained in detail, the embodiments are not limited in their application to the details of the configuration and arrangement of components set forth in the following description or illustrated in the accompanying drawings. The embodiments are capable of being practiced or of being carried out in various ways. Also, the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”) unless otherwise specified. As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

Although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

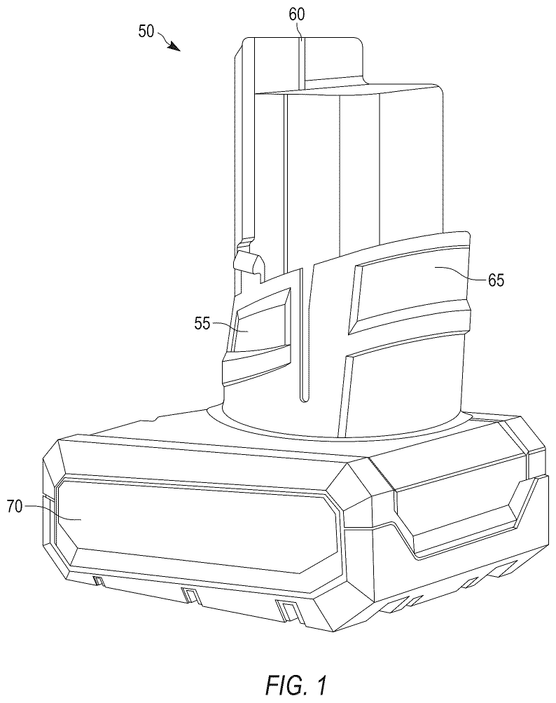

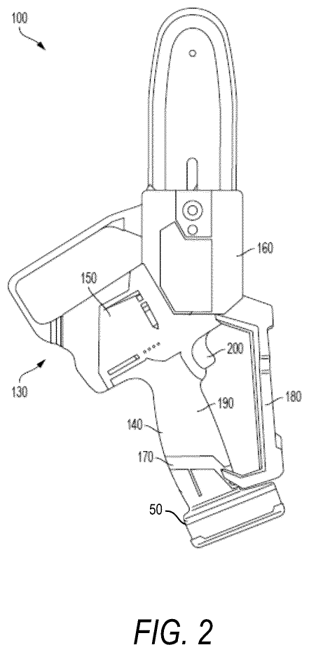

FIG. 1 illustrates an example embodiment of a battery pack 50 for providing power to and communicating with a power tool, such as power tool 100 (FIG. 2). The battery pack 50 includes a housing 55 and a device interface 60 for connecting the battery pack 50 to a power tool (e.g., the power tool 100) or a charger. In the example illustrated, the housing 55 includes a vertical portion 65 and a horizontal portion 70. The housing 55 may be made of hardened plastic material using, for example, an injection molding, 3D printing, or other similar process. In some examples, the housing 55 may be made of constituent half-housings that are joined together using fasteners. The device interface 60 is provided on a top edge of the vertical portion 65, furthest away from the horizontal portion 70. In some embodiments, the battery pack 50 may not include the horizontal portion 70, for example, in a lower capacity configuration.

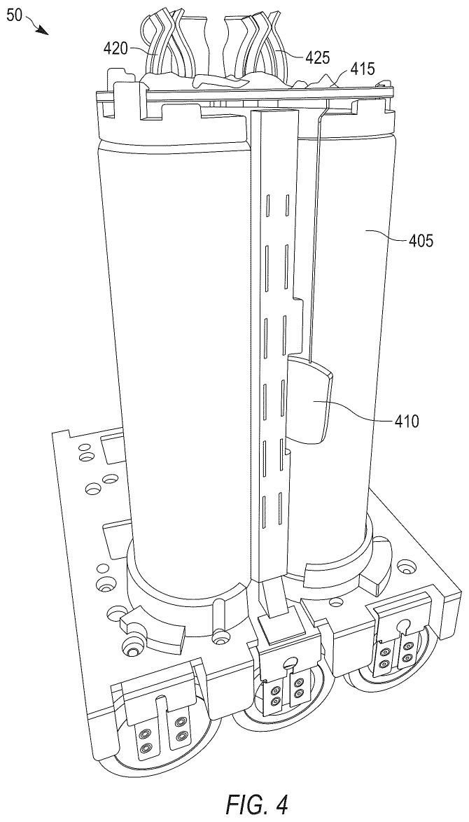

The battery pack 50 may include one or more lithium-ion battery cells, such as battery cells 405 (FIG. 4). In some embodiments, the battery pack 50 may be of a different chemistry, for example, nickel-cadmium, nickel-metal hydride, and the like. In some embodiments, the battery pack 50 may include six ‘18650’ battery cells having a nominal voltage of 3.6 Volts (“V”) each provided in a 3S2P (two parallel strings of three series connected battery cells). For example, three cells may be provided in the vertical portion 65 and three cells may be provided in the horizontal portion 70. In some embodiments, the battery pack 50 may include three ‘18650’ battery cells connected in series to form a lower capacity configuration, i.e., without the horizontal portion 70. In yet other embodiments, a different configuration of one or more battery cells may be used. In some embodiments, the density of the battery cells may be increased from conventional densities.

In the illustrated embodiment, the battery pack 50 has a nominal output voltage of 10.8 V. In other embodiments, the output voltage level of the battery pack 50 may be different. For example, the battery pack 50 can be a 3.6 V battery pack, 18 V battery pack, 36 V battery pack, or another voltage. The battery pack 50 may also have various capacities (e.g., 1.2, 2, 3, 4, 5, 6, 8, or 12 Ampere-hours).

FIG. 2 illustrates an example embodiment of a power tool 100. In the example illustrated, the power tool 100 is a powered handheld pruner or a portable chainsaw. The chainsaw 100 is powered by the rechargeable power tool battery pack 50. For example, the illustrated battery pack 50 is an interchangeable battery pack configured to connect to and power a variety of tools in addition to the chainsaw 100.

With continued reference to FIG. 2, the chainsaw 100 includes a housing 130. The housing 130 defines a handle housing portion 140, a motor housing portion 150 and a drive housing portion 160. In the illustrated embodiment, the handle housing portion 140 extends from the drive housing portion 160 and the motor housing portion 150. In other embodiments, the handle housing portion 140 may extend from either the drive housing portion 160 or the motor housing portion 150. In the illustrated embodiment, the handle housing portion 140 includes a battery receiving portion 170 disposed opposite the motor housing portion 150. At least a portion of the battery pack 50 may be coupled to the battery receiving portion 170. In other embodiments, the battery receiving portion 170 may be defined elsewhere on or within the housing 130.

Referring to FIG. 2, the illustrated housing 130 further includes a handle guard 180 that extends between the drive housing portion 160 and the battery receiving portion 170. The handle housing portion 140 includes at least one grip surface 190 for a user to grasp while operating the chainsaw 100. The handle guard 180 may support removable adjusting tools or buttons for adjusting settings on the chainsaw 100. A trigger 200 is positioned on the handle housing portion 140 for operating the chainsaw 100. As illustrated, the trigger 200 is an on/off trigger switch. In other embodiments, the trigger 200 may be a variable speed trigger switch, a two-speed trigger switch, a push button, or another suitable actuator.

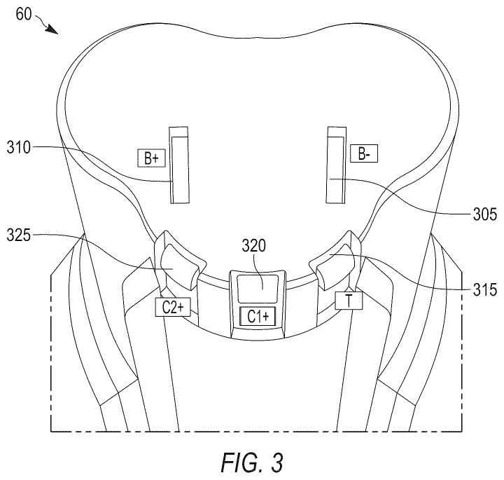

FIG. 3 illustrates a perspective view of the device interface 60 of the battery pack 50, according to some embodiments. The device interface 60 includes a negative terminal port 305 and a positive terminal port 310. The negative terminal port 305 and the positive terminal port 310 facilitate an electrical connection between the battery receiving portion 170 and the battery cells of the battery pack 50 via a negative terminal and a positive terminal, such as negative terminal 420 and positive terminal 425 (FIG. 4).

In addition to the negative terminal port 305 and the positive terminal port 310, the device interface 60 includes a temperature terminal (“T terminal”) 315, a first communication terminal 320, and a second communication terminal 325. The T terminal 315 provides a voltage to the power tool 100 that indicates a temperature of the battery cells or the power terminals 420, 425. Based on the voltage at the T terminal 315, the power tool 100 determines whether to allow discharge of the battery pack 50. The power tool 100 may prevent discharge of the battery pack 50 when the T terminal 315 indicates a high temperature condition. The first communication terminal 320 provides a cell tap between the least positive battery cell and the middle battery cell (e.g., in a 3S or 3S2P configuration) and the second communication terminal 325 provides a cell tap between the middle battery cell and the most positive battery cell to the power tool 100.

FIG. 4 illustrates an example embodiment of the battery pack 50 with the housing 55 removed. In the example illustrated, the battery pack 50 includes a plurality of battery cells 405, a thermistor 410, and a printed circuit board (“PCB”) 415. The thermistor 410 senses a temperature of the battery cells 405 and, in particular, the temperature of a first battery cell 405 of the battery cells 405. For example, the thermistor 410 is placed directly on the first battery cell 405 (e.g., the most positive battery cell) for monitoring the temperature of the first battery cell 405. The thermistor 410 may be placed in physical contact with the first battery cell 405. The thermistor 410 is, for example, a negative temperature coefficient (“NTC”) thermistor, a positive temperature coefficient (“PTC”) thermistor, or the like. The resistance of the thermistor 410 changes based on an ambient temperature, that is, a temperature of the battery cells 405. For example, when the temperature of the first battery cell 405 changes, the electrical resistance of the thermistor 410 changes resulting in a change in current flowing through and the voltage across the thermistor 410. The temperature of the battery cells 405 is determined based on the change in current/voltage across the thermistor 410.

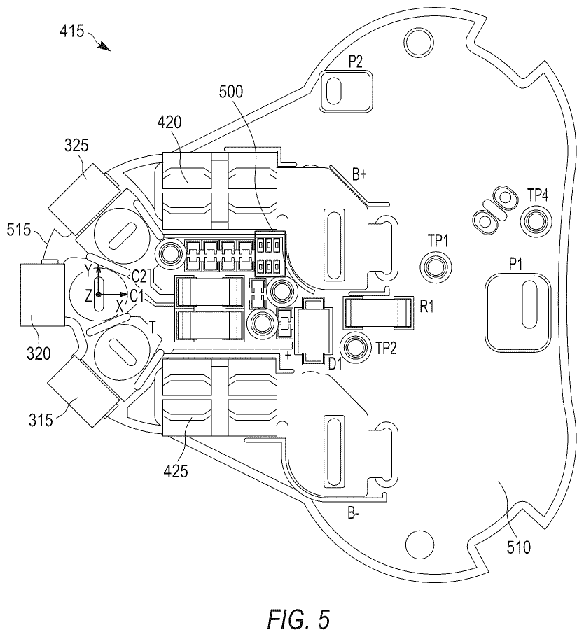

The PCB 415 is provided at a top portion of the battery cells 405. For example, the top portion of the battery cells 405 is physically proximate to the device interface 60. A negative battery terminal 420 and a positive battery terminal 425 are mounted on the PCB 415. The negative battery terminal 420 and the positive battery terminal 425 may be collectively referred to as the power terminals 420, 425 and individually referred to as the power terminal 420, 425. In the example illustrated, the power terminals 420, 425 are clamp shaped and are configured to receive blade terminals of the power tool 100. In other examples, the power terminals 420, 425 may be blade terminals that are received in clamp shaped terminals of the power tool 100. The thermistor 410 is electrically connected to the PCB 415 at an opposite end of a physical connection between the thermistor 410 and the first battery cell 405. Referring to FIG. 5, the PCB 415 is generally triangular and includes devices mounted on a first side 510 of the PCB 415. For example, a temperature integrated circuit (“IC”) 500, the negative battery terminal 420, and the positive battery terminal 425 are mounted on the first side 510 of the PCB 415. The T terminal 315, the first communication terminal 320, and the second communication terminal 325 are provided along a front edge 515 of the PCB 415. The temperature IC 500 is provided adjacent to the positive terminal 425 (e.g., in thermal contact with the power terminal 425).

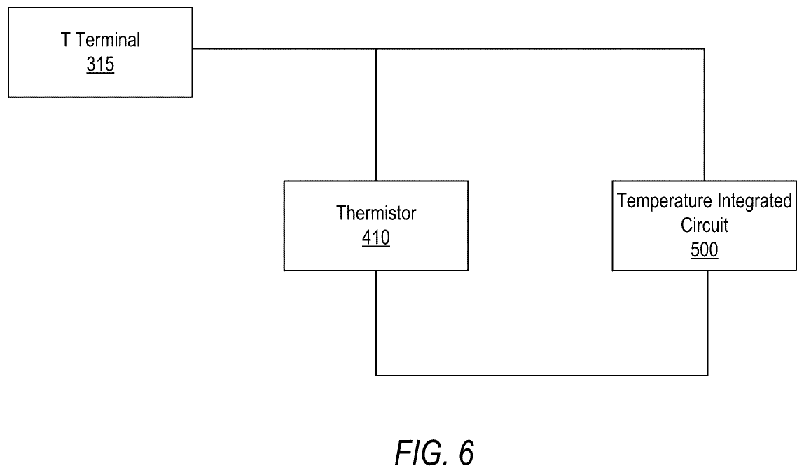

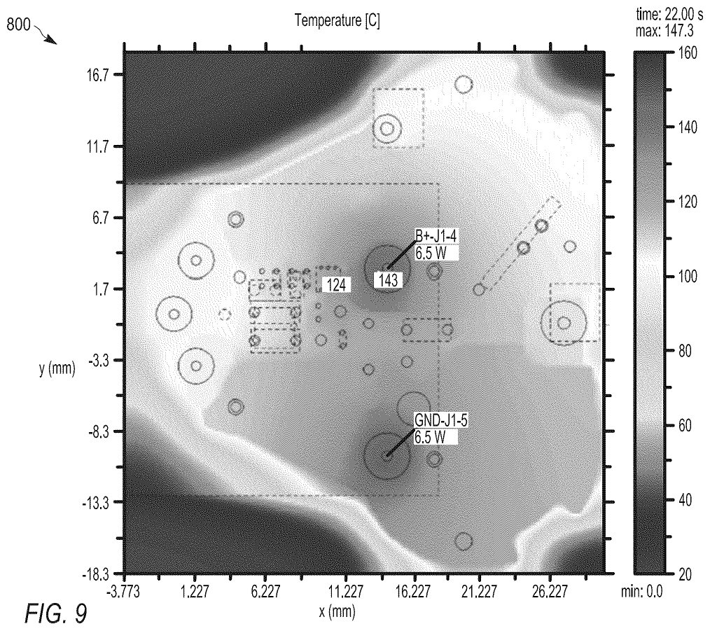

FIG. 6 is a simplified block diagram of the battery pack 50. In the example illustrated, a temperature IC 500 is electrically connected to the thermistor 410 and the T terminal 315 within the battery pack 50. Both the temperature IC 500 and the thermistor 410 may independently drive the voltage at the T terminal 315. The temperature IC 500 monitors the temperature of the power terminals 420, 425 of the battery pack 50. In some embodiments, the temperature IC 500 engages (e.g., the temperature IC 500 is “tripped”) when the positive terminal 425 is greater than 130° C. When the temperature IC 500 is tripped, the temperature IC 500 pulls the T terminal 315 low, regardless of the battery cell 405 temperature that is monitored using the thermistor 410. When the temperature IC 500 is not tripped, the voltage seen by the power tool 100 at the T terminal 315 reflects the voltage driven by the thermistor 410 alone. Table 1 (below) displays an example of the relationship between battery cell 405 temperature, thermistor 410 resistance, and a voltage at the T terminal 315. In one example, when the battery cell 405 temperature is greater than or equal to 75° C., the thermistor 410 resistance is less than 1.5 kOhms, and the T terminal 315 voltage is less than 0.4 V. The power tool 100 may detect this voltage (e.g., a voltage falling below 0.5 V) at the T terminal 315 and stops/prevents discharge from the battery pack 50 until the voltage at the T terminal 315 recovers (e.g., returns above 0.4 V) to operate the motor of the power tool 100. However, a small amount of current may still be discharged to operate a controller 900 (see FIG. 9) that monitors the voltage at the T terminal 315.

TABLE 1

| Battery Cell | Thermistor | T Terminal |
|---|---|---|
| Temperature (° C.) | Resistance (kOhm) | Voltage (V) |
| 10 | 20 | 2.2 |
| 25 | 10 | 1.7 |
| 60 | 2.5 | 0.7 |
| 75 | 1.5 | 0.4 |
| >75 | — | 0 |

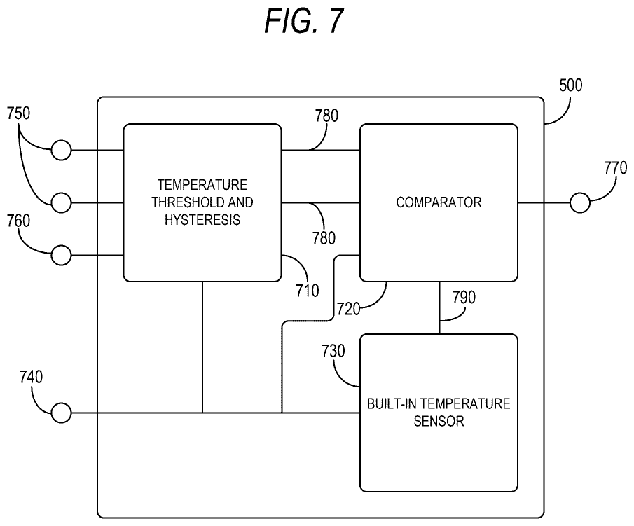

FIG. 7 illustrates a simplified block diagram of an example embodiment the temperature IC 500. In one example, the temperature IC 500 may be implemented using a temperature switch, for example, Texas Instruments' Temperature Switch with part no. TMP302D. In the example illustrated, the temperature IC 500 includes a temperature threshold and hysteresis circuit 710, a comparator 720, and a built-in temperature sensor 730. The temperature IC 500 also includes a supply voltage pin 740, temperature setting pins 750, hysteresis setting pin 760, and an output pin 770. The supply voltage pin 740 receives the operating power supply for powering the components of the temperature IC. In one example, the nominal supply voltage is 3.3 V. The temperature setting pins 750 and the hysteresis setting pin 760 are connected to the temperature threshold and hysteresis circuit 710. In the example illustrated, the temperature setting pins 750 include two pins to receive, for example, to receive a two-bit input (e.g., supply voltage=1; ground=0) to set the temperature threshold. The temperature setting pins 750 may therefore be used to set the temperature threshold to four different values. The hysteresis setting pin 760 may receive a one-bit input to set the hysteresis for the comparison of a detected temperature to the temperature threshold. In one example, the hysteresis may be set to 5° Celsius (“C”) or 10° C. based on the one-bit input.

The temperature threshold and hysteresis circuit 710 receives the temperature setting from the temperature setting pins 750 and the hysteresis setting from the hysteresis setting pin 760 and provides temperature threshold signals 780 to the comparator 720. In one example, the temperature threshold signals 780 include a first temperature threshold signal providing the temperature threshold set using the temperature setting pins 750 and a second temperature threshold signal that is set based on the temperature setting and the hysteresis setting. The built-in temperature sensor 730 may be a thermistor similar to the thermistor 410. The built-in temperature sensor 730 provides a temperature signal 790 corresponding to the ambient temperature of the temperature IC 500 to the comparator 720. The comparator 720 may operate in two states: (i) normal state; and (ii) tripped state. In the normal state, the output of the comparator at the output pin 770 is high (e.g., supply voltage). In the normal state, the comparator 720 compares the temperature signal 790 to the first temperature threshold signal to compare the temperature to the set temperature threshold. When the temperature exceeds the temperature threshold, the comparator 720 drives the output pin 770 low (e.g., a low voltage, ground, etc.) and enters the tripped state. In the tripped state, the comparator 720 compares the temperature signal 790 to the second temperature threshold signal to account for hysteresis. When the temperature is below the hysteresis temperature threshold, the comparator drives the output pin 770 high (e.g., supply voltage) and enters the normal state.

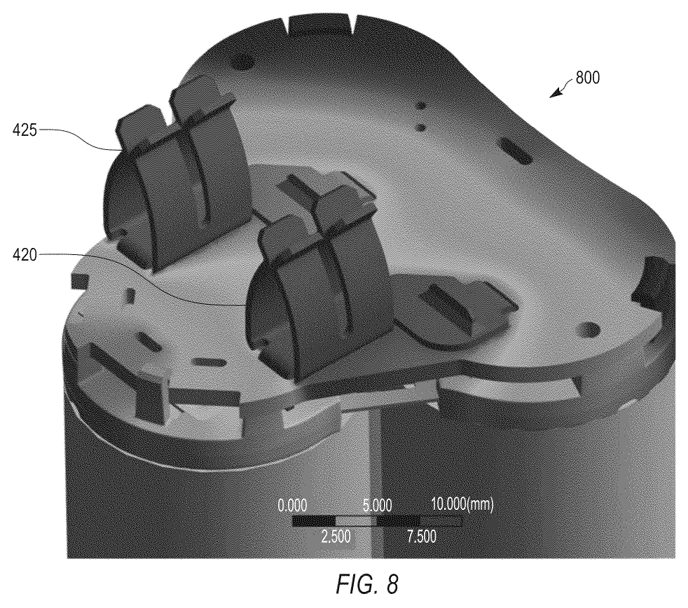

FIGS. 8 and 9 illustrate an example heat map 700 of the PCB 415. As can be seen from the heat map 700 the negative battery terminal 420 and the positive battery terminal 425 may generate heat during operation (e.g., during discharge). Heat is concentrated around the negative battery terminal 420 and the positive battery terminal 425. For example, the PCB 415 is hottest concentrated around the negative battery terminal 420 and the positive battery terminal 425 and radially cools as a distance from the negative battery terminal 420 and the positive battery terminal 425 increases. The concentration of heat at the negative battery terminal 420 and the positive battery terminal 425 may cause the housing 55 to heat up and, in some cases, melt. The temperature IC 500 is therefore positioned adjacent (i.e., in thermal contact with) one of the power terminals 420, 425 as shown in FIG. 5 such that the temperature IC 500 can effectively detect the temperature of the power terminals 420, 425 using the built-in temperature sensor 730. Thermal contact between the temperature IC 500 and the power terminal 420, 425 may be provided by placing the temperature IC 500 adjacent the power terminal 420, 425 without needing a physical contact between the temperature IC 500 and the power terminal 420, 425.

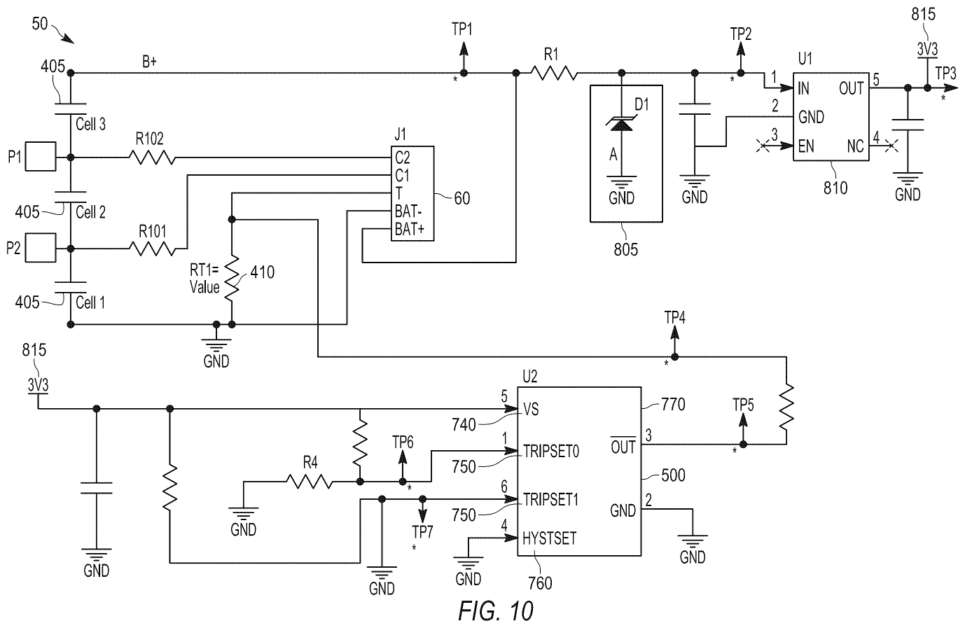

FIG. 10 illustrates a schematic of the battery pack 50, according to some embodiments. In the example illustrated, the battery pack 50 includes an electrostatic discharge protection circuit 805 and a low dropout circuit 810 electrically connected to the positive battery terminal 425, and the temperature IC 500 electrically connected to the T terminal 315. The low dropout circuit 810 converts the voltage from the battery cells 405 to a supply voltage 815 to be provided to other components of the battery pack 50, for example, to the temperature IC 500. In one example, the low dropout circuit 810 converts the output voltage of the battery cells 405 to 3.3 V that is provided as a supply voltage 815 to the temperature IC 500.

The battery pack 50 also includes additional circuits to provide the inputs to the temperature IC 500. In the example illustrated, the battery pack 50 is not a smart battery pack, that is, the battery pack 50 does not include a controller (e.g., a microcontroller or microprocessor). The inputs to the temperature IC 500 are provided using electrical circuitry rather than from a controller. The supply voltage 815 from the low dropout circuit 810 is provided to the supply voltage pin 740 of the temperature IC 500. In the example illustrated, voltage dividers are used to set the temperature setting pins 750 to high (e.g., supply voltage or voltage above ground). The pin 760 is connected to ground to set the hysteresis to, for example, 5° C. The output pin 770 is coupled to the T terminal 315 along with the thermistor 410.

In one example, the power from the battery pack 50 is used to power both a load of the power tool 100 and a housekeeping power supply of the power tool through two current paths. The housekeeping power supply may provide a power supply to power certain sensing and/or control components (e.g., a controller) of the power tool 100. A discharge FET may be provided in the power tool 100 between the power terminal and the load, but not between the power terminal and the housekeeping power supply such that the discharge to the load is terminated when the discharge FET is opened, but the housekeeping power supply may continue to power the control components in the power tool 100. The housekeeping power supply may provide a voltage (e.g., 3.3 Volts) at a device temperature terminal of the power tool electrically connected to the T terminal 315. The housekeeping power supply may be electrically connected to the device temperature terminal using a resistor such that the resistor and the thermistor 410 form a voltage divider at the T terminal 315. The voltage at the device T terminal 315 exhibits the voltage as shown in the above table based on the supply voltage from the housekeeping power supply. The voltage at the T terminal 315 is detected by the controller (e.g., controller 1205) to determine the temperature of the battery cell of the power terminal 420, 425 and control the discharge FET accordingly. When the temperature of the power terminal 420, 425 is below the temperature threshold, the temperature IC 500 may provide a high signal or high impedance such that minimum to no current flows to the temperature IC 500 and the temperature being detected is solely the temperature measured by the thermistor 410. When the temperature of the power terminal 420, 425 is above the temperature threshold, the temperature IC 500 may provide a low signal or low impedance such that most or all current flows to the temperature IC 500 bypassing the thermistor 410.

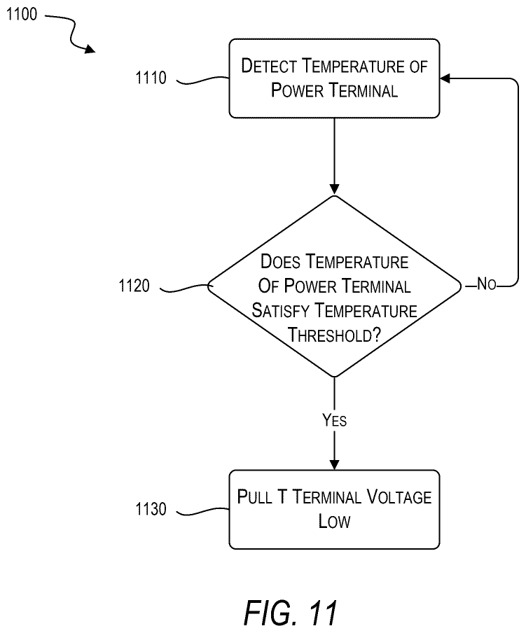

FIG. 11 illustrates a flowchart of an example method 1100 for battery pack terminal temperature monitoring. Although the illustrated method 1100 includes specific steps, not all steps need to be performed or need to be performed in the order presented. In some embodiments, the method 1100 is executed by the battery pack 50, and in particular, the temperature IC 500.

The method 1100 includes detecting, using the built-in temperature sensor 730, a temperature of a power terminal 420, 425 of the battery pack (step 1110). As discussed above, the temperature IC 500 is positioned adjacent one of the power terminals 420, 425 to detect the ambient temperature around the power terminals 420, 425. The built-in temperature sensor 730 provides a temperature signal 790 to a comparator 720 of the temperature IC 500 based on the ambient temperature around the temperature IC 500.

The method 1100 includes comparing, using the temperature IC 500, the temperature of the power terminal to a temperature threshold (step 1120). The comparator 720 of the temperature IC 500 compares the temperature signal 790 from the built-in temperature sensor 730 to a temperature threshold set using the temperature setting pins 750. The temperature threshold is set to, for example, one of 110° C., 115° C., 120° C., 125° C., or the like. In one example the temperature threshold of the temperature IC 500 is selected to detect when the power terminal 420, 425 is at 130° C., for example, based on the heat map 800 (see FIG. 8). Although the set point maximum for the temperature threshold is 125° C. in the above example, the temperature IC 500 takes the hysteresis into account for the trip condition such that the temperature is compared to a threshold of the selected temperature trip point (125° C.) plus the hysteresis (e.g., 5° C.) to arrive at the trip point of 130° C. Therefore, the temperature threshold may be set between 100° C. and 135° C. and the hysteresis may be set between 5° C. and 10° C.

The method 1100 includes pulling, using the temperature IC 500, the T terminal 315 low in response to the temperature of the power terminal 420, 425 satisfying the temperature threshold (at step 1130). The temperature of the power terminal 420, 425 satisfies the temperature threshold when the temperature of the power terminal 420, 425 is, for example, equal to or greater than the temperature threshold. The comparator 720 drives the output pin 770 and thereby the T terminal 315 low when the temperature of the power terminal 420, 425 satisfies the temperature threshold. In one example, “low” means that the voltage output at the T terminal 315 is less than or equal to 0.7V.

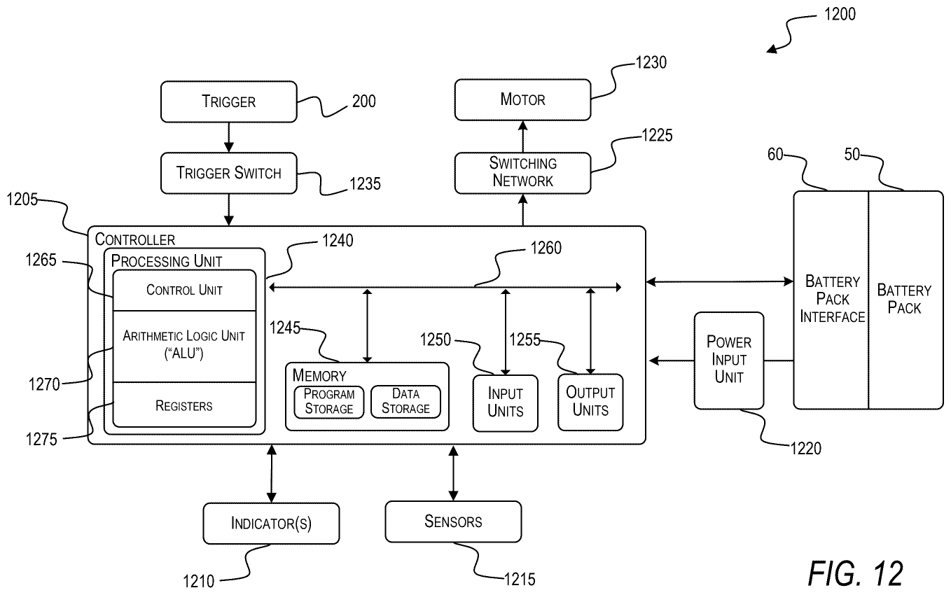

FIG. 12 is a block diagram of a controller 1200 of the power tool 100, according to some embodiments. The controller 1200 is electrically and/or communicatively connected to a variety of modules or components of the power tool 100. For example, the illustrated controller 1200 is connected to indicators 1210 (e.g., LEDs, tactile indicators, audible indicators, etc.), sensors 1215 (e.g., a current sensor, a voltage sensor, a torque sensor, a trigger pull sensor, a temperature sensor, etc.), a power input unit 1220, a switching network 1225, and a trigger switch 1235.

The controller 1200 includes a plurality of electrical and electronic components that provide power, operational control, and protection to the components and modules within the controller 1200 and/or power tool 100. For example, the controller 1200 includes, among other things, a processing unit 1240 (e.g., a microprocessor, an electronic processor, an electronic controller, a microcontroller, or another suitable programmable device), a memory 1245, input units 1250, and output units 1255. The processing unit 1240 includes, among other things, a control unit 1265, an arithmetic logic unit (“ALU”) 1270, and a plurality of registers 1275 (shown as a group of registers in FIG. 12), and is implemented using a known computer architecture (e.g., a modified Harvard architecture, a von Neumann architecture, etc.). The processing unit 1240, the memory 1245, the input units 1250, and the output units 1255, as well as the various modules connected to the controller 1200 are connected by one or more control and/or data buses (e.g., common bus 1260). The control and/or data buses are shown in FIG. 12 for illustrative purposes. The use of one or more control and/or data buses for the interconnection between and communication among the various modules and components would be known to a person skilled in the art in view of the embodiments described herein.

The memory 1245 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 1240 is connected to the memory 1245 and executes software instruction that are capable of being stored in a RAM of the memory 1245 (e.g., during execution), a ROM of the memory 1245 (e.g., on a generally permanent basis), or another non-transitory computer readable medium such as another memory or a disc. Software included in the implementation of the power tool 100 can be stored in the memory 1245 of the controller 1200. The software includes, for example, firmware, one or more applications, program data, filters, rules, one or more program modules, and other executable instructions. The controller 1200 is configured to retrieve from the memory 1245 and execute, among other things, instructions related to the control processes and methods described herein. In other embodiments, the controller 1200 includes additional, fewer, or different components.

A motor 1230 is energized based on a state of the trigger 200. Generally, when the trigger 200 is activated, the motor 1230 is energized, and when the trigger 200 is deactivated, the motor 1230 is de-energized. In the illustrated embodiment, the trigger 200 is coupled to a trigger switch 1235 such that when the trigger 200 is depressed, the trigger switch 1235 is activated, and when the trigger 200 is released, the trigger switch 1235 is deactivated.

The switching network 1225 enables the controller 1200 to control the operation of the motor 1230. The switching network 1225 includes a plurality of electronic switches (e.g., FETs, bipolar transistors, and the like) connected to form a network that controls the activation of the motor 1230 using a pulse-width modulated (“PWM”) signal. For instance, the switching network 1225 may include a six-FET bridge that receives PWM signals from the controller 1200 to drive the motor 1230. Generally, when the trigger 200 is depressed as indicated by an output of the trigger switch 1235, electrical current is supplied from the power input unit 1220 to the motor 1230 via the switching network 1225. When the trigger 200 is not depressed, electrical current is not supplied from the power input unit 1220 to the motor 1230.

The device interface 60 of the battery pack 50 is coupled to the power input unit 1220 when the battery pack 50 is coupled to the power tool 100. The power input unit 1220 may include a battery pack interface having corresponding power and communication terminals (e.g., temperature terminal) that mate with the corresponding power, temperature, and communication terminals of the device interface 60 of the battery pack 50. The power input unit 1220 includes active and/or passive components (e.g., voltage step-down controllers, voltage converters, rectifiers, filters, etc.) to regulate or control the power received through the device interface 60 to the controller 1200. In some embodiments, the controller 1200, via the power input unit 1220, determines that a voltage of the T terminal 315 is low and prevents discharge from the battery pack 50. The power input unit 1220 may be electrically and communicatively coupled to terminals of the power tool 100. For example, the power tool 100 may include blade terminals or clamp terminals that mate with at least one of the T terminal 315, the first communication terminal 320, the second communication terminal 325, and the power terminals 420, 425 of the battery pack 50.

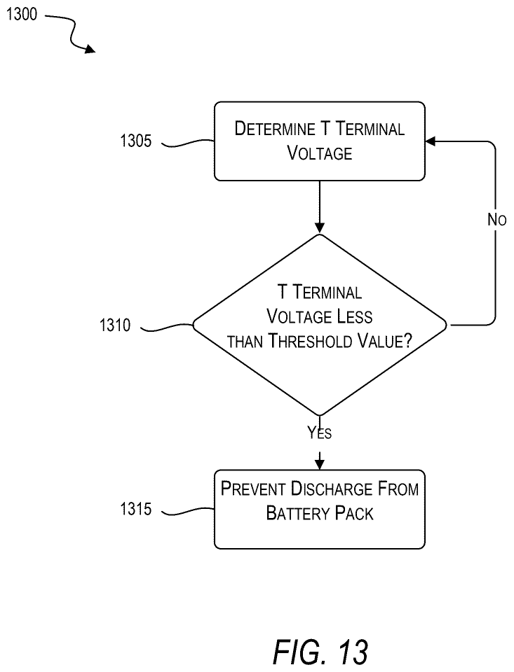

FIG. 13 illustrates a flowchart of a method 1300 for battery pack temperature monitoring. Although the illustrated method 1300 include specific steps, not all steps need to be performed or need to be performed in the order presented. In some embodiments, the method 1300 is executed by the power tool controller 1200.

The method 1300 includes determining, using the power tool controller 1200, a T terminal 315 voltage (step 1305). In some embodiments, the power input unit 1220 senses a voltage output from the T terminal 315 of the battery pack 50 and the power tool controller 1200 determines the voltage value. At decision step 1310, the power tool controller 1200 determines whether the T terminal 315 voltage value is less than a threshold value. In some embodiments, the threshold value is stored in the memory 1245 and the processing unit 1240 compares the T terminal 315 voltage value to the stored threshold value. The threshold value may be set to, for example, 0.5 V. When the T terminal 315 voltage is less than the threshold value (YES at decision step 1310), the method 1300 proceeds to step 1315. When the T terminal 315 voltage value is not less than the threshold value (i.e., the T terminal 315 voltage is greater than the threshold value) (NO at decision step 1310), the method 1300 proceeds back to step 1315.

At step 1315, the power tool controller 1200 prevents discharge from the battery pack 50. In some embodiments, the power tool controller 1200 will not allow discharge until a voltage corresponding to a release temperature is detected at the T terminal 315. For example, the release temperature may correspond to a 5° C. hysteresis with respect to the temperature threshold. The temperature IC 500 may provide a hysteresis release which is detected by the power tool controller 1200 at the T terminal 315. For example, the temperature IC 500 may set a release temperature threshold based on the hysteresis and the temperature threshold (i.e., 130° C.-5° C.=125° C.). When the temperature of the power terminal 420, 425 falls below the release temperature threshold, the temperature IC 500 may drive the T terminal 315 high (i.e., release the T terminal 315). The power tool 100 may include a discharge FET that is connected to one of the positive or negative power terminals. The power tool controller 1200 may discharge from the battery pack 50 by opening the discharge FET such that no discharge current can flow from the battery pack 50 to the power tool 100.

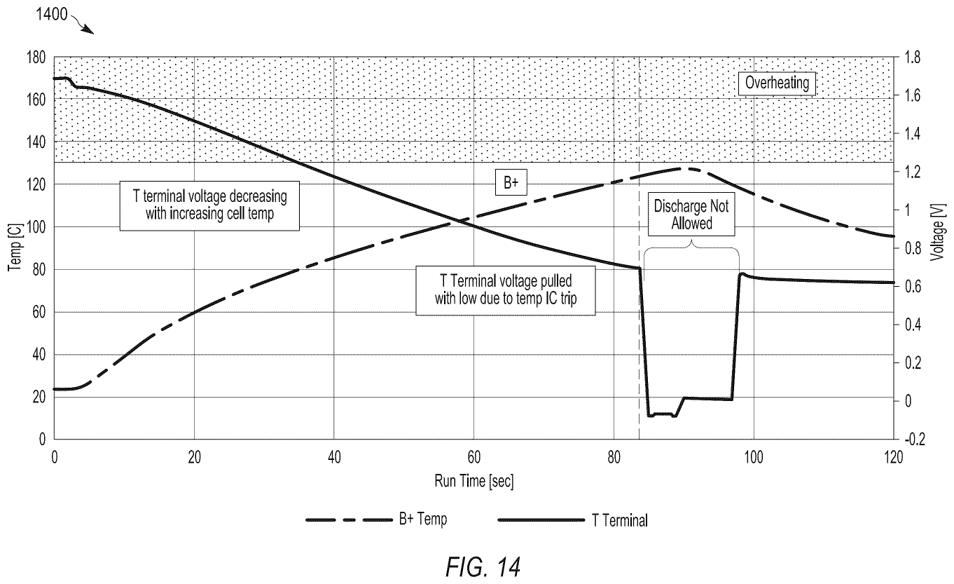

FIG. 14 is a graph 1400 illustrating a temperature-based output of T terminal 315, according to some embodiments. The x-axis is a run time of the battery pack 50 (i.e., measured in seconds), first y-axis is the temperature of a battery cell 405 (i.e., measured in degrees Celsius (° C.)), and the second y-axis is the T terminal 315 voltage (i.e., measured in volts (V)). As the battery cell 405 temperature increases (and subsequently the positive terminal 425 temperature increases), the T terminal 315 voltage decreases. In some embodiments, the battery cell 405 temperature increase and T terminal 315 voltage decrease occur linearly. In some embodiments, the temperature IC 500 trips when the positive terminal 425 temperature is greater than a threshold value. In some embodiments, discharge is prevented when the temperature IC 500 is tripped. In some embodiments, the T terminal 315 voltage recovers after the temperature IC 500 hysteresis is released.

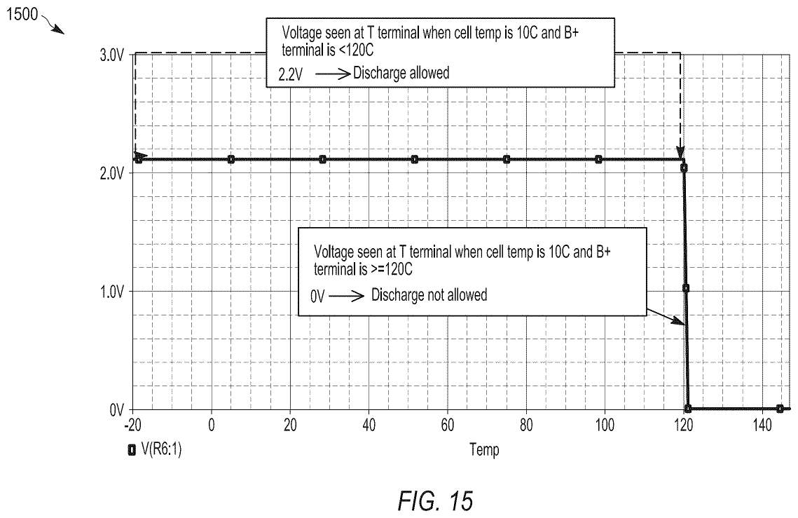

FIG. 15 illustrates a first temperature integrated circuit operation example 1500, according to some embodiments. In some embodiments, the temperature IC 500 will not impact battery cell 405 temperature communication between the battery pack 50 and the power tool 100 based on the signals from the thermistor 410. In the present example, the power tool 100, and, in particular, the power tool controller 1200, sees the voltage at the T terminal 315 as 2.2V when the battery cell 405 temperature is 10° C. and the positive terminal 425 temperature is less than 120° C. In response to the voltage at the T terminal 315 being 2.2V when the battery cell 405 temperature is 10° C. and the positive terminal 425 temperature being less than 120° C., discharge of the battery pack 50 is allowed. When the power tool 100, and, in particular, the power tool controller 120, sees the voltage at the T terminal 315 as 0V when the battery cell 405 temperature is 10° C. and the positive terminal 425 temperature is greater than or equal than 120° C., the temperature IC 500 is tripped. When the temperature IC 500 is tripped, discharge of the battery pack 50 is not allowed. However, as noted above, small amounts of power may be discharged, for example through the power terminals 420, 425 or T terminal 315 to maintain operation of the controller 1200.

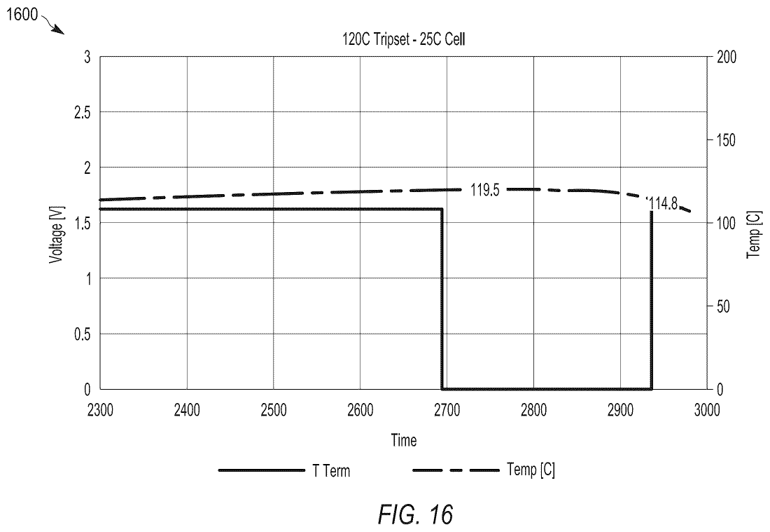

FIG. 16 illustrates a second temperature integrated circuit operation example 1600 when the battery cells 405 are at room temperature (e.g., 25° C.). The x-axis is a run time of the battery pack 50 (i.e., measured in seconds), first y-axis is the T terminal 315 voltage (i.e., measured in volts (V)), and the second y-axis is the temperature of a battery cell 405 (i.e., measured in degrees Celsius (° C.)). In some embodiments, the temperature IC 500 is tripped when the 120° C. threshold is reached. For example, the T terminal 315 voltage may be 1.7V when the power terminal 420, 425 is below 120° C. The T terminal 315 voltage is pulled low when the temperature IC 500 is tripped. The T terminal 315 voltage recovers after a 5° C. hysteresis.

Thus, embodiments described herein provide, among other things, a battery pack with a temperature integrated circuit for communicating a temperature of a battery cell and battery pack terminal to a power tool.

What is claimed is:

1. A battery pack including:
a housing;
a battery cell within the housing;
a power terminal and a temperature terminal; and
a temperature integrated circuit in thermal contact with the power terminal and electrically connected to the temperature terminal and configured to:
detect a temperature of the power terminal,
compare the temperature to a temperature threshold, and
pull the temperature terminal low in response to the temperature satisfying the temperature threshold.

2. The battery pack of claim 1, wherein pulling the temperature terminal low includes setting a voltage at the temperature terminal to less than 0.7V.

3. The battery pack of claim 1, further comprising a thermistor in thermal contact with the battery cell and electrically connected to the temperature terminal and configured to control a voltage at the temperature terminal independently of the temperature integrated circuit.

4. The battery pack of claim 3, wherein the temperature integrated circuit is configured to drive the temperature terminal when the temperature is greater than or equal to the temperature threshold, and wherein the thermistor is configured to drive the temperature terminal when the temperature is below the temperature threshold.

5. The battery pack of claim 1, wherein the power terminal is a positive power terminal of the battery pack configured to receive a power terminal of a power tool.

6. The battery pack of claim 1, further comprising:
a first communication terminal providing a cell tap between a least positive battery cell and a middle battery cell; and
a second communication terminal providing a cell tap between a most positive battery cell and a middle battery cell.

7. The battery pack of claim 1, further comprising a printed circuit board, wherein the power terminal, the temperature terminal, and the temperature integrated circuit are mounted to the printed circuit board.

8. The battery pack of claim 7, further comprising a device interface configured to receive an electronic device, wherein the printed circuit board is provided at a top portion of the battery cell between the battery cell and the device interface.

9. The battery pack of claim 1, wherein the temperature integrated circuit includes a temperature setting pin and a built-in temperature sensor, wherein the temperature of the power terminal is sensed by the built-in temperature sensor, the temperature integrated circuit is further configured to:
set the temperature threshold based on an input received at the temperature setting pin.

10. The battery pack of claim 9, wherein the input is a first input and wherein the temperature integrated circuit includes a hysteresis setting pin, the temperature integrated circuit is further configured to:
set a hysteresis based on a second input received at the hysteresis setting pin;
determine a release temperature threshold based on the temperature threshold and the hysteresis; and
release the temperature terminal when the temperature satisfies the release temperature threshold.

11. The battery pack of claim 10, wherein the temperature threshold is set to between 100° C. and 130° C.

12. The battery pack of claim 10, wherein the hysteresis is set to between 5° C. and 10° C.

13. A system comprising:
a battery pack including:
a device interface having a power terminal and a temperature terminal; and
a power tool including:
a power input unit configured to connect to the device interface, and
a controller coupled to the power input unit and configured to:
determine a voltage of the temperature terminal,
compare the voltage of the temperature terminal to a threshold value, and
prevent, in response to determining the voltage of the temperature terminal is less than the threshold voltage, the battery pack from discharging.

14. The system of claim 13, wherein the controller prevents discharge until a voltage corresponding to a release temperature is detected at the temperature terminal.

15. The system of claim 14, wherein the release temperature corresponds to between 5° C. and 10° C. hysteresis with respect to the temperature threshold.

16. The system of claim 13, wherein the threshold value is 0.5 V.

17. The system of claim 13, wherein the temperature threshold is set to between 100° C. and 130° C.

18. A printed circuit board comprising:
a power terminal;
a temperature terminal; and
a temperature integrated circuit in thermal contact with the power terminal and electrically connected to the temperature terminal and configured to:
detect a temperature of the power terminal,
compare the temperature to a temperature threshold, and
pull the temperature terminal low in response to the temperature of the power terminal satisfying the temperature threshold.

19. The printed circuit board of claim 18, wherein the temperature integrated circuit includes a temperature setting pin and a built-in temperature sensor, wherein the temperature of the power terminal is sensed by the built-in temperature sensor, the temperature integrated circuit is further configured to:
set the temperature threshold based on an input received at the temperature setting pin.

20. The printed circuit board of claim 19, wherein the input is a first input and wherein the temperature integrated circuit includes a hysteresis setting pin, the temperature integrated circuit is further configured to:
set a hysteresis based on a second input received at the hysteresis setting pin;
determine a release temperature threshold based on the temperature threshold and the hysteresis; and
release the temperature terminal when the temperature satisfies the release temperature threshold.
